(19) United States
(12) Patent Application Publication
(10) Pub. No.: US 2007/0287001 A1
(43) Pub. Date: Dec. 13, 2007

(54) SOUND-ABSORBING ENGINE COMPARTMENT LINING FOR MOTOR VEHICLES

(75) Inventors: Larry Carlson, Brighton, MI (US); Gordon Ebbitt, Ann Arbor, MI (US)

Correspondence Address: MILLER, CANFIELD, PADDOCK AND STONE;MARJORY G. BASILE, ESQ., 150 W. JEFFERSON, SUITE 2500, DETROIT, MI, 48226, US

(73) Assignee: Carcoustics Tech Center GmbH, Leverkusen (GE)

(21) Appl. No.: 11/623,442

(22) Filed: Jan. 16, 2007

(30) Foreign Application Priority Data
Jun. 9, 2006 (GE) 20 2006 009 245.5

(51) Int. Cl. B32B 3/26; B32B 5/24; D21H 11/00; B32B 3/00; D21H 13/00

(52) U.S. Cl. 428/304.4; 428/311.11; 428/312.2; 428/311.51

(57) ABSTRACT

An airborne sound-absorbing engine compartment lining for motor vehicles comprises an open-cell, air-permeable foam material layer made from plastic and having a front side and a rear side. The foam material layer is provided on its rear side with a fiber layer made from mineral fibers, the foam material layer having a thickness of less than 6 mm and a specific flow resistivity in the range from about 100 to 1,200 Ns/m³. The fiber layer has a thickness of more than 6 mm and a mass per unit area of less than 800 g/m².

### RELATED APPLICATION

This application claims priority benefit of German utility model patent application No. 20 2006 009 245.5 filed on Jun. 9, 2006.

### FIELD OF THE INVENTION

This invention relates to improvements in sound absorbing linings, and more particular to an airborne sound-absorbing engine compartment lining for motor vehicles in the form of an engine hood lining with an open-cell, air-permeable foam material layer made from plastic.

### BACKGROUND OF THE INVENTION

Motor vehicles are usually equipped with sound-absorbing engine hood linings for reducing noise levels. The rigidity of conventional engine hood linings made from foam material is frequently unsatisfactory. Also a problem exists in the case of engine compartment linings made from foam material which concerns the inflammability of the foam material, if the foam material does not contain a flame retardant.

Furthermore sound-absorbing engine hood linings having a fiberglass layer are well-known. Although fiberglass is advantageous in respect of its behavior in fires and the rigidity of an engine hood lining made thereof, being of light-weight construction it possesses only relatively minimum acoustic effectiveness. In order to achieve the same acoustic effectiveness with a fiberglass layer as with an open-cell foam material, the fiberglass layer must have a density, which is substantially greater than the density of an open-cell foam material. Furthermore a fiberglass layer does not offer as good a visual appearance as a foam material layer.

### SUMMARY OF THE INVENTION

In accordance with a first aspect, a sound-absorbing lining of the kind described above is provided which is relatively light in weight, self-supporting, has flame resistance and also good acoustic effectiveness.

In accordance with another aspect, an engine compartment lining is provided which comprises an open-cell, air-permeable foam material layer made from plastic, which is provided on its rear side with a fiber layer made from mineral fibers, wherein the foam material layer has a thickness of less than 6 mm and a specific flow resistivity in the range from 100 to 1,200 Ns/m³, while the fiber layer has a thickness of more than 6 mm and a mass per unit area of less than 800 g/m².

### BRIEF DESCRIPTION OF THE DRAWINGS

The invention is described below in detail on the basis of a drawing illustrating several embodiments, wherein there is shown schematically:

FIG. 1 is a perspective frontal view of a motor vehicle with open engine hood and an engine hood lining fastened thereto.

FIG. 2 is a cross sectional view of a section of an engine hood lining according to a preferred embodiment of the invention.

FIG. 3 is a cross sectional view of a section of an engine hood lining according to another preferred embodiment of the invention.

FIG. 4 is a cross sectional view of a section of a third preferred embodiment of an engine hood lining.

FIG. 5 is a cross sectional view of a section of a fourth preferred embodiment of an engine hood lining.

FIG. 6 a cross sectional view of a section of a fifth preferred embodiment of an engine hood lining.

### DETAILED DESCRIPTION OF CERTAIN PREFERRED EMBODIMENTS

The material structure of the engine compartment lining according to the invention combines the advantageous properties of mineral fiber and foam material. A relatively thin foam material layer is provided on the front or visible side of the lining whereby, compared with the use of a fiberglass layer only, an improved external appearance is achieved. In particular the foam material layer advantageously allows for the option of creating clearly visible design features. For example decorative relief patterns or other three-dimensional structures can be stamped or impressed into the foam material layer. The thin foam material layer is formed or made up according to the invention so that it has a relatively high flow resistivity, guaranteeing good sound absorption. By contrast the fiber layer is formed comparatively thickly. Its mineral fibers are layered in loose suspension, so that the fiber layer is soft and easily compressible. As the largest part of the lining according to the invention consists of mineral fibers, preferably glass fibers, it is relatively simple to produce a flame-resistant material structure. The fiber layer imparts good rigidity and natural stability to the lining according to the invention. The fiber layer can be of comparatively light-weight construction, since the fiber layer primarily serves as a backing for the thin foam material layer. The thin foam material layer in turn principally has the sound-absorbing function of the self-supporting engine compartment lining.

The engine compartment lining according to the invention can be manufactured more economically than corresponding linings, which substantially consist of foam material, since in order to achieve sufficient rigidity it does not require the use of expensive fiber matrices, which are frequently necessary in the case of conventional sound-absorbing linings based on foam material. On the other hand the engine compartment lining according to the invention is substantially lighter in weight than conventional engine compartment linings with a sound-absorbing function, essentially consisting of fiberglass. These conventional linings made from fiberglass require a very high density of glass fibers, if they are to offer a sound-absorption capacity which corresponds to the generic linings made from foam material.

The thickness of the foam material layer, which preferably consists of polyurethane-foam material, in the case of the engine compartment lining according to the invention is preferably less than half the thickness of the fiber layer. The thickness of the foam material layer for example can be in the range from approx. 10 to 45% of the thickness of the fiber layer. Particularly preferred is an embodiment, in which the thickness of the foam material layer is less than a third, in particular less than a quarter of the thickness of the fiber layer.

In accordance with a particularly preferred embodiment the foam material layer has a thickness of less than 5 mm and a specific flow resistivity in the range from 300 to 1,200 Ns/m³.

In order to achieve good sound absorption capacity it is proposed in accordance with another advantageous refinement of the invention that the foam material layer possesses on its front side an integral, skin-like surface layer, which has a higher specific flow resistivity than the following sublayer (remaining layer).

The integral, skin-like surface layer is preferably produced by sintering the surface of the foam material layer. The specific flow resistivity of the surface layer is preferably in the range from approximately 400 to 2,000 Ns/m³.

Alternatively or additionally a layer having a high flow resistivity can be applied to one or both sides of the foam material layer, that is to say in particular between the foam material layer and the fiber layer. This additional layer may be a perforated foil or thin fleece made from natural or synthetic fibers.

The thickness of the perforated foil is for example in the range from 10 to 120 μm, while the average diameter of its perforations (holes) is in the range from approx. 0.05 to 4 mm, in particular approx. 0.2 to 3 mm. The foil is for example made from polyethylene, polyamide, polyethylene terephthalate, polypropylene or polyester.

The thin fleece that may be applied to the foam material layer is preferably made from polyethylene terephthalate fibers, polypropylene fibers and/or polyester fibers. The specific flow resistivity of the perforated foil or the thin fleece is in a range from 400 to 2,000 Ns/m³.

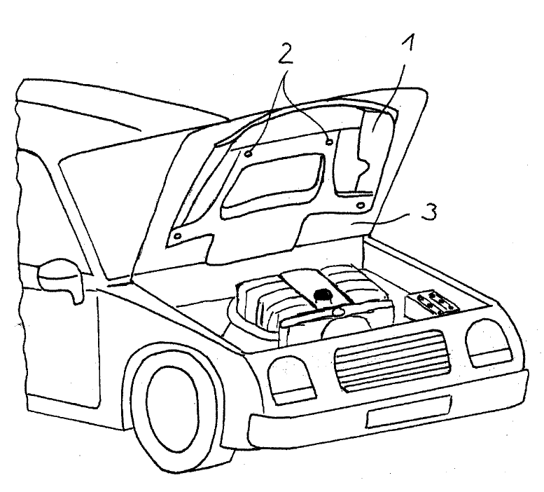

FIG. 1 illustrates an airborne sound-absorbing engine compartment lining 1, which is fastened with tie-clips 2 or the like to the lower face of an engine hood 3 of a motor vehicle.

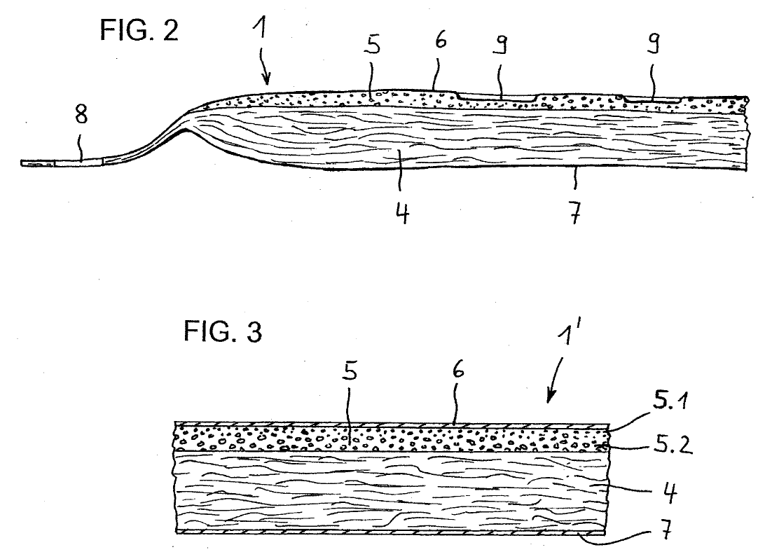

The engine hood lining 1 is formed so as to be self-supporting and is essentially structured by a fiber layer 4 made from mineral fibers and a relatively thin open-cell foam material layer 5 (see FIG. 2). As the result of the fiber layer 4 the air-permeable foam material layer 5 is maintained at a distance from the sheet metal of the engine hood 2 or a car body panel.

The fiber layer 4 preferably consists of fiberglass. It can however also be made from rock fibers or rock wool or a mixture of various mineral fibers. The glass fibers or mineral fibers form a relatively loose, soft layer, which is substantially thicker than the foam material layer 5. The average thickness of the fiber layer 4 is in the range from approx. 7 to 20 mm; it is preferably more than 9 mm, for example approx. 15 mm.

The mass per unit area of the flame-resistant fiber layer 4 is in the range from 200 to 800 g/m², for example approx. 400 g/m². The fiber layer 4 is preferably relatively light in weight. Its mass per unit area is preferably less than 400 g/m², in particular less than 300 g/m².

The foam material layer 5 preferably consists of polyurethane-foam material and has a density in the range from 5 to 40 kg/m³, preferably in the range from 5 to 25 kg/m³. The thickness of the foam material layer 5 is in the range from 2 to 6 mm, it is for example only approx. 4 mm. It has a relatively high specific flow resistivity, which is in the range from 100 to 1,200 Ns/m³, preferably in the range from 300 to 1,200 Ns/m³ (Rayls).

The front side, that is to say the side of the foam material layer 5 facing the vehicle engine is provided with a thin covering fleece 6. The covering fleece 6 is bonded to the foam material layer 5. A corresponding covering fleece 7 is arranged on the rear side of the fiber layer 4. The total thickness of the engine hood lining 1 is approximately 12 to 25 mm. As illustrated in FIG. 2, the layers 3 to 6 are compressed together in the peripheral region of the lining 1. The total layer thickness there for example is less than 3 mm. Holes 8 can be formed in the compressed peripheral region for accommodating tie-clips 2 or other fastening elements, which can be connected to the engine hood 3 or the car body panel.

The foam material layer 5 also has a design function apart from the acoustic function. As can be recognized in FIG. 2 recesses 9, which are part of a decorative relief structure, not illustrated in detail, for example a proprietary emblem of the motor vehicle manufacturer, are worked or impressed into the front side of the foam material layer (including the covering fleece 6 arranged thereon).

FIG. 3 illustrates an embodiment, in which the foam material layer 5 on its front side has an integral, skin-like surface layer 5.1, which possesses a higher specific flow resistivity than the following sublayer 5.2. The surface layer 5.1 facing the engine is preferably sintered though thermal treatment by means of a heat radiator or forming tool heated up more than usual. The specific flow resistivity of the surface layer 5.1 is in the range from approximately 400 to 2,000 Ns/m³, more preferably in the range from approximately 400 to 1,600 Ns/m³. Surface layer 5.1 has a greater density than the remaining part 5.2, integral therewith, of the foam material layer 5. The density of the surface layer 5.1 is in the range from approx. 40 to 200 kg/m³.

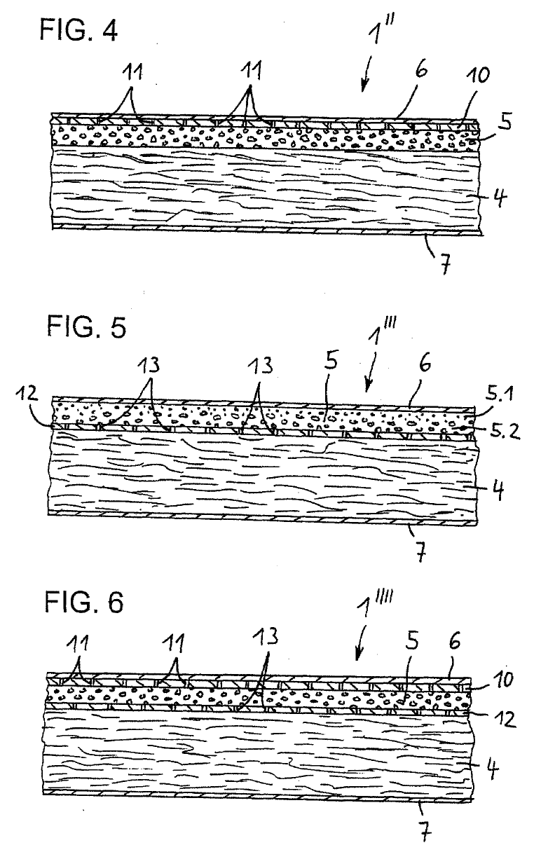

In FIG. 4 a further embodiment of an engine compartment lining 1″ according to the invention is outlined. The material structure according to FIG. 4 essentially only differs from the material structure according to FIG. 2 in that an even thinner layer 10, which has a higher specific flow resistivity than the foam material layer 5 or increases the flow resistivity of the foam material layer 5 at least substantially, is arranged on the side of the thin foam material layer 5 facing the engine.

This additional layer 10 is a perforated foil, which has a plurality of small holes 11 with an average diameter in the range from approx. 0.2 to 3.0 mm. The foil 10 is approx. 15 to 100 μm thick and may consist in particular of polyamide or polyethylene.

FIG. 5 illustrates a further embodiment. The material structure according to FIG. 5 only differs from that of FIG. 3 in that a perforated foil 12 which has a plurality of perforations 13 with an average diameter in the range from 0.05 to 4 mm is arranged between the foam material layer 5 and the fiber layer 4.

In the embodiment outlined in FIG. 6 a perforated foil 10, 12 is finally arranged both on the front side of the foam material layer 5 and also between the foam material layer 5 and the fiber layer 4 in each case. The average diameter of the many small perforations 11, 13 is again in the range from 0.01 to 4 mm, preferably in the range from 0.02 to 1 mm.

In the embodiments shown in FIGS. 4 to 6, according to the invention at least one fleece with a specific flow resistivity in the range from 100 to 2,000 Ns/m³, preferably in the range from 300 to 1,800 Ns/m³ (Rayls), can also be used in place of the respective foil 10, 12. As regards the fleece various fiber materials are applicable, in particular natural fibers, polyethylene terephthalate fibers and/or polypropylene fibers.

Implementation of the invention is not limited to the examples described above and illustrated in the drawing. On the contrary further variants, which make use of the concepts according to the invention, indicated in the appended claims, are also possible in the case of an embodiment deviating to this extent. Thus for example the invention can also be realized in the case of a dashboard lining arranged in the engine compartment.

What is claimed is:

1. An airborne sound-absorbing engine compartment lining for motor vehicles, comprising:
an open-cell, air-permeable foam material layer made from plastic and having a front side and a rear side, wherein the foam material layer is provided on its rear side with a fiber layer made from mineral fibers, the foam material layer having a thickness of less than 6 mm and a specific flow resistivity in the range from about 100 to 1,200 Ns/m³, and the fiber layer having a thickness of more than 6 mm and a mass per unit area of less than 800 g/m².

2. The engine compartment lining of claim 1 wherein the thickness of the foam material layer is less than half the thickness of the fiber layer.

3. The engine compartment lining of claim 1 wherein the foam material layer has a thickness of less than 5 mm and a specific flow resistivity in the range from about 300 to 1,200 Ns/m³.

4. The engine compartment lining of claim 1 wherein the fiber layer has a thickness of more than 9 mm and a mass per unit area of less than 450 g/m².

5. The engine compartment lining of claim 1 further comprising a foil which has a plurality of perforations with an average diameter in the range from 0.05 to 4 mm arranged between the foam material layer and the fiber layer.

6. The engine compartment lining of claim 1 further comprising a foil having a plurality of perforations with an average diameter in the range from 0.01 to 4 mm arranged on the front side of the foam material layer.

7. The engine compartment lining of claim 6 wherein the perforated foil comprises one of polyamide, polyethylene, polyethylene terephthalate, polypropylene and polyester.

8. The engine compartment lining according of claim 6 wherein the perforated foil has a specific flow resistivity in the range from 400 to 2,000 Ns/m³.

9. The engine compartment lining of claim 1 further comprising a fleece which has a specific flow resistivity in the range from 400 to 2,000 Ns/m³ arranged between the foam material layer and the fiber layer.

10. The engine compartment lining of claim 9 wherein the fleece has a specific flow resistivity in the range from about 300 to 1,800 Ns/m³ and is arranged on the front side of the foam material layer.

11. The engine compartment lining of 9 wherein the fleece comprises one of polyethylene terephthalate fibers, polypropylene fibers and polyester fibers.

12. The engine compartment lining of claim 1 wherein the foam material layer has a density in the range from 5 to 40 kg/m³.

13. The engine compartment lining of claim 1 wherein the foam material layer is a single-layer having on its front side an integral, skin-like surface layer which has a higher specific flow resistivity than a sublayer of the foam material layer immediately adjacent the surface layer.

14. The engine compartment lining of claim 13 wherein the integral skin-like surface layer has a specific flow resistivity in the range from 400 to 2,000 Ns/m³.

15. The engine compartment lining of claim 13 wherein the integral, skin-like surface layer is a sintered surface layer.

16. The engine compartment lining of claim 13 wherein the integral, skin-like surface layer has a density in the range from 40 to 200 kg/m³.

17. The engine compartment lining of claim 1 wherein the foam material layer comprises polyurethane foam.

18. The engine compartment lining of claim 1 wherein the fiber layer comprises one of glass fibers and rock fibers.

19. The engine compartment lining of claim 1 wherein the front side is provided with a covering fleece.

20. The engine compartment lining of claim 19 wherein the covering fleece is bonded to the foam material layer.

21. The engine compartment lining of claim 1 wherein a covering fleece is arranged on the rear side of the fiber layer.

22. The engine compartment lining of claim 1 wherein the fiber layer, foam material layer, a covering fleece on the front side of the fiber layer and a covering fleece on the rear side of the fiber layer are compressed together with a total layer thickness of less than 3 mm.

23. The engine compartment lining of claim 22 wherein holes are formed in a compressed peripheral region to accommodate fastening elements.

24. The engine compartment lining of claim 1 wherein the front side of the foam material layer defines several recesses forming patterns.
